(19) United States
(12) Patent Application Publication
(10) Pub. No.: US 2014/0057769 A1
(43) Pub. Date: Feb. 27, 2014

(54) METHOD AND DEVICE FOR CONNECTING TWO FILM WEBS

(71) Applicants: Rolf Steinemann, Neuhausen (CH); Jan Thaerigen, Lohningen (CH); Markus Wehrli, Schaffhausen (CH); Alfred Wipf, Jestetten (DE)

(72) Inventors: Rolf Steinemann, Neuhausen (CH); Jan Thaerigen, Lohningen (CH); Markus Wehrli, Schaffhausen (CH); Alfred Wipf, Jestetten (DE)

(73) Assignee: ROBERT BOSCH GMBH, Stuttgart (DE)

(21) Appl. No.: 14/111,803

(22) PCT Filed: Apr. 11, 2012
(86) PCT No.: PCT/EP2012/056574

§ 371 Date: Oct. 15, 2013

(30) Foreign Application Priority Data
Apr. 15, 2011 (DE) 102011007457.0

(51) Int. Cl. B23P 19/04

(52) U.S. Cl. CPC B23P 19/04
USPC 493/381

(57) ABSTRACT

A splicing method serves for connecting an active film web (2) which is wound up on a first reel (4) to a passive film web (3) which is wound up on a further reel (8). The active film web (2) is unwound from the first reel (4) and is fed to at least one processing station. When a remaining film quantity of the active film web (2) is reached on the first reel (4), the active film web (2) is spliced or connected to the passive film web (3), with the result that the passive film web is pulled by the active film web (2) into the at least one processing station and therefore changes from the passive film web into the active film web. Before the operation of splicing, the outer side (18) of the passive film web (3) is provided with a connecting element (19), and the active film web (2) and the passive film web (3) are moved towards one another before the operation of splicing, wherein the active film web (2) is pressed against the further reel (8) with the passive film web (3) and the passive film web (3) is thus spliced to the active film web (2) via the connecting element (19).

### BACKGROUND OF THE INVENTION

The present invention relates to a method for connecting two film webs and a corresponding device.

Tubular bag machines pack products in a film by a bag from a film web being formed around the products, sealing seams on the longitudinal and transversal side being produced and the individual packets being separated. The film web is mounted to the machine in the form of a reel and is unrolled there. The film web is then fed to processing stations, such as, for example, to a folding device.

The prior art, such as, for example, the European patent specification EP 0 061 788 discloses how a second reel can be prepared while the film web is being fed to the packaging machine from the first reel. If said first reel is exhausted, the first film web or the first reel is connected to the second film web of the second reel by a splicing device in a so-called splicing operation in order to feed the film web to the second reel in succession of a packaging machine. To this end, the start of the new film of the new reel is provided with an adhesive tape or something similar and positioned such that the start of the film of the new reel is connected to the end of the film of the old reel during the splicing operation by means of the adhesive tape. In so doing, the new film is pulled into the machine. The spliced area of the film is processed normally by the machine, wherein the products comprising the spliced portion of the film are removed. In the case of this solution, it has proven to be a disadvantage that the adhesive connection cannot always withstand the tensile stress on the film web, wherein a separation of the film web of the old reel and that of the new reel can occur, which then leads to a stoppage of the machine in order to rethread the film web.

The joining of the films according to the European patent specification EP 0 061 788 takes place in the following manner: After detecting the end of a first film reel of the tubular bag machine, the end of the exhausted film web and the start of the new film web are pressed together as a result of two deflection rollers of the first and respectively the second film web being pressed together by means of an electromagnet and are subsequently connected by means of adhesive tape. Said joining is performed in accordance with centering marks on the film so that the centering marks of the old and the new film are positioned on top of each other in this splicing operation and thus the regular intervals of the imprints on both films is maintained. In so doing, the result is then only very few products (in the ideal case only that product comprising the splicing seam) have to be removed. In this way, the replacing of an old exhausted reel with a new one can likewise be performed without stopping the machine.

The disadvantage of the technical teaching of the European patent specification EP 0 061 788 is that the second new film web is prepared at rest and thus the new web after splicing is accelerated from the resting state to full speed. This is only possible up to certain maximum speeds. At higher speeds, the machine has to be throttled because otherwise the connection between the two film webs cannot be carried out in compliance with the requirements; and particularly the aforementioned problem of tearing can occur.

Furthermore, the start of the new film web is prepared with adhesive tape and placed between the two deflection rollers. The two rollers (left/right) have to be prepared in different ways because the films are pulled in a mirror-inverted manner. This can lead to a faulty preparation which in turn can lead to a stoppage of the machine. The film has subsequently to be completely removed and be threaded in again, which generally requires several minutes.

In addition, the preparation of the start of the new film web is critical. The film web has to be provided with adhesive tape and be placed in the proximity of the active web. In so doing, the active web can catch the adhesive tape and could unintentionally pull in the new film, which likewise leads to a stoppage of the machine. The new film must also be exactly positioned with regard to the centering mark. This position is not always at the same place in the case of different films and different pull-off lengths, which can lead to faults.

### SUMMARY OF THE INVENTION

Given this prior art, the aim underlying the invention is to specify a method and a device which overcome the disadvantages of the prior art. In particular, the connecting process between the old and the new film web is intended to be improved.

A splicing method according to the invention meets such an aim. A splicing method for connecting an active film web which is wound on a first reel to a passive film web which is wound on a second reel accordingly serves this end. The active film web is unwound and is fed to at least one processing station. When a remaining film quantity of the active film web is reached on the first reel, the active film web is spliced or connected to the passive film web, with the result that the passive film web is pulled by the active film web into the at least one processing station and therefore changes from the passive film web into the active film web. Before the operation of splicing, the outer side of the passive film web is provided with a connecting element. Furthermore, the active film web and the passive film web are moved relatively towards one another. During the operation of splicing, the active film web is pressed against the second or further reel with the passive film web, and the passive film web is thus spliced to the active film web via the connecting element.

With such a method, a simplified production of a spliced connection between an exhausted and a new film web is provided. By pressing the one film web against the reel with the other film web, a reliable form of connection can be provided, which improves the connecting process as a whole.

The outer side of the film or the film web refers to the side which faces to the outside in the wound state. Similarly, the inside of the film or the film web is the side which faces to the inside towards the center of the reel in the wound state.

The relative movement between the active film web and the passive film web occurs, as seem temporally, preferably directly prior to the splicing operation. The relative movement can be discontinuous, wherein this relates then to a prepositioning of the two films with respect to one another; or the movement can transition directly into the splicing operation.

In a preferable manner, the second or further reel with the passive film web can be accelerated prior to the operation of splicing such that the peripheral speed of the second or further reel is substantially equal to the speed of the active film web, the passive film web and the active film web moving in the same direction. In addition, the first or active reel can be throttled, whereby the speeds of the two film webs are more quickly aligned. By aligning the speeds, the films can be connected to one another with a throttling of the film speed. A sudden acceleration of the passive film web by the active film web during splicing can be prevented. In addition, forces or the strength of a jolt during splicing are reduced. The risk of the spliced connection tearing can also be reduced.

The movement of the further reel with the passive film web can preferably be synchronized to the movement of the active film web, whereby the active film web runs in particular position-synchronously with the passive film web. In so doing, possible imprints, sealing layers of cold sealing films, opening aids or other film properties of the passive and active film web can be synchronized and a subsequent synchronization of the film web in the processing machine can be omitted, whereby the scrap material can additionally be reduced.

The film start can preferably be identified with a special mark. The splice can thereby be recognized. The connecting element is very preferably identified with color, wherein the connecting element is then the mark. In so doing, said connecting element can be recognized and spliced in the correct position. After mounting the new passive reel, a check can optionally be made by means of suitable detection as to whether said reel is present or has been activated.

The synchronization of the two film webs can be provided particularly by means of detecting position marks that have been applied to the film web, which marks are positioned relative to the print image or other recurring film features. The position mark is preferably used on the passive film web for synchronization, said position mark being disposed behind the connecting element relative to the direction of movement of the passive film web.

In a preferable manner, a position mark or even the mark which is present for detecting the film start can be used to check whether the reel has been mounted to the machine in the correct position. After the new reel has been mounted, said reel can preferably be rotated into a suitable position using suitable sensors.

The active film web is preferably severed after the splicing operation has been completed. This prevents a loose film end from being pulled along and allows for a good insertion of the new film web into the processing station. The length whereat two film webs are pulled so as to overlap into the processing station, can be reduced, whereby the number of packagings that have to rejected can be reduced.

During the splicing operation, the inner side of the active film web can preferably be connected to the outer side of the passive film web so that the active film web and the passive film web have the same orientation with respect to the surfaces thereof. The inner side of the active film web is preferably pressed against the connecting element on the outer side of the passive film web on the passive reel. As a result, provision does not have to be made for films wound in different directions. A different preparation of the reels can likewise thereby be omitted, which in turn reduces the likelihood of malfunction.

The start of the passive film web, which is spliced to the active film web, is preferably secured to a locking device on the outer side of the wound passive film web. In so doing, the passive film web can be prevented from unintentionally unwinding. The locking device preferably has a lower resistance to being detached than the connecting element of the spliced connection. It can thereby be ensured that the locking device and not the spliced connection releases during the splicing operation. The locking device is preferably designed as an adhesive connection.

A splicing device serves to produce a spliced connection of an active film web, which is wound up on a first reel, to a passive film web, which is wound up on a further reel, wherein the active film web is unwound from the first reel. The splicing device substantially serves to carry out the splicing method. The splicing device comprises a first axis of rotation comprising the first reel and at least one further axis of rotation comprising in each case a further reel and a pressing unit. The further reel with the passive film web has a connecting element on the outer side thereof, wherein the active film web and the passive film web can be moved relatively towards one another before the operation of splicing. During the operation of splicing, the active film web can be pressed with the pressing unit against the further reel with the passive film web, and the passive film web can thus be spliced to the active film web via the connecting element.

### BRIEF DESCRIPTION OF THE DRAWINGS

Preferred embodiments of the invention are described below with the aid of the drawings, which only serve for explanation and are not to be interpreted in a manner which limits the invention. In the drawings:

FIG. 1 shows a schematic perspective view of a splicing device according to one embodiment.

FIG. 2 shows a schematic lateral view of the splicing device according to FIG. 1 in the operating state.

FIG. 3 shows a schematic lateral view of the splicing device according to FIG. 1 shortly before the splicing operation.

FIG. 4 shows a schematic lateral view of the splicing device according to FIG. 1 during the splicing operation.

FIGS. 5-7 show different examples of the design of the film start of the new reel.

FIGS. 8-10 show a configuration for the use of the splicing device according to one of the FIGS. 1 to 4.

### DETAILED DESCRIPTION

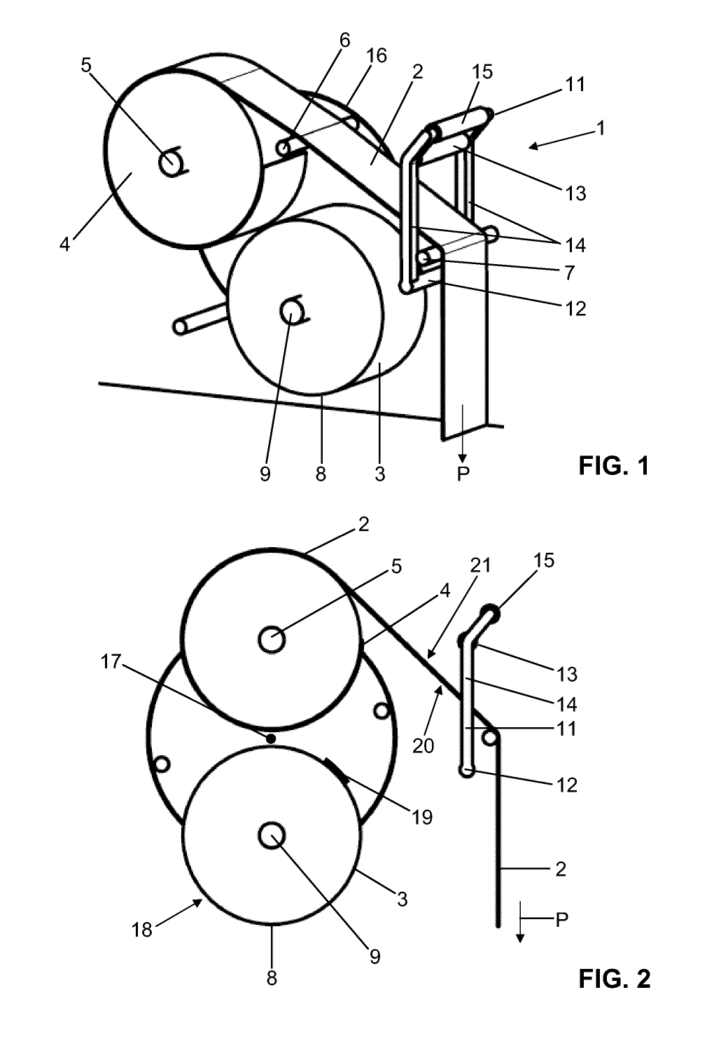

In FIG. 1, a splicing device 1 for producing a spliced connection between a first or old film web 2 and a second or new film web 3 according to the present invention is shown. The film web relates particularly to a cold sealing film or a hot sealing film for producing a tubular bag. That is why the sealing film can also be referred to as a tubular bag film. The film web is then fed from the splicing device 1 to at least one further processing station. The further processing station can, for example, be a packaging station, in which bulk material or individual portions are packaged by means of the tubular bag film.

The splicing device 1 comprises at least two rotational axes 5, 9 for receiving the reels with the film webs and a pressing unit 11, which is used to produce the spliced connection or rather to support the splicing. In the present embodiment, a first rotational axis 5, on which a first reel 4 with the first film web 2 is mounted, and a second rotational axis 9, on which a second reel 8 with the second film web 3 is mounted, are present.

The reel from which the film web is unwound and fed to the processing unit can be referred to as the active or old reel. The corresponding rotational axis is then analogously the active rotational axis and the film web the active film web. In the figures, the first reel 4 is the active reel and therefore the first rotational axis 5 is the active rotational axis.

The other rotational axes or reels from which a film web is not unwound can be referred to as passive rotational axes or passive reels or the passive film web. In the figures, the second reel 8 is the passive reel and the second rotational axis is the passive rotational axis.

The loose end of the passive reel can be referred to in this context as the film start and the end of a completely unwound reel as the film end.

The film web 2 of the active reel 4 is spliced or connected to the film web 3 of the passive reel 8 by means of the splicing device 1. Before the film end 10 of the active film web 2 is reached, the splicing device 1 provides for splicing the active film web 2 to the passive film web 3; thus enabling the passive film web 3 to be pulled into the further processing stations by the active film web 2. This has the advantage that a complex insertion of the passive film web 3 can be omitted. As a result, the passive reel changes into the active reel after splicing has been completed because the film web is now unwound from said reel. The previously active reel, the film web of which has been unwound or processed down to a remaining film quantity, is then removed and a new reel is inserted into the splicing device 1.

It can further be seen in FIG. 1 that the splicing device 1 can comprise several optional deflection rollers. The first or active film web 2 is guided via a first deflection roller 6 and second deflection roller 7 out of the splicing device 1 and moves along the arrow P. The unwinding of the film web from the first reel 4 takes place, for example, by means of drive rollers (not depicted) which pull the film web along the arrow P.

The active rotational axis 5 can be optionally equipped with a brake so that the film web can be unwound in a controlled manner. To this end, each of the rotational axes 5, 9 can comprise a separate brake or else be coupled via a common brake.

The pressing unit 11 will now be explained with the aid of FIG. 1. A pressing force is applied to the splice via the pressing unit 11 so that the active film web 2 can be connected to the passive film web 3. The pressing unit 11, which can be pivoted about an axis 12, comprises in this case a pressing roller 13 which is connected to the pivot axis 12 by means of two brackets disposed parallel to one another. The appropriate pressing force is exerted on the splicing point via the pressing roller 13. The pressing unit 11 can further comprise a deflection roller 15 which can guide the first film web onto the splice at a better angle.

It can also be seen from FIG. 1 that the splicing device comprises a turret wheel 16. The first rotational axis 5 comprising the associated deflection roller 6, the second rotational axis 9 comprising the associated deflection roller 6 are disposed in the present embodiment on the turret wheel 16, which can be pivoted about a rotational axis that is shown in FIG. 2 having a pivot point 17. The active film web 2 and the passive film web 3 can be moved relative to each other by means of the pivoting motion of the turret wheel 16; thus enabling the splicing operation to be carried out in a manner that is described below. It should be noted in this context that the relative movement can also be executed by some other means.

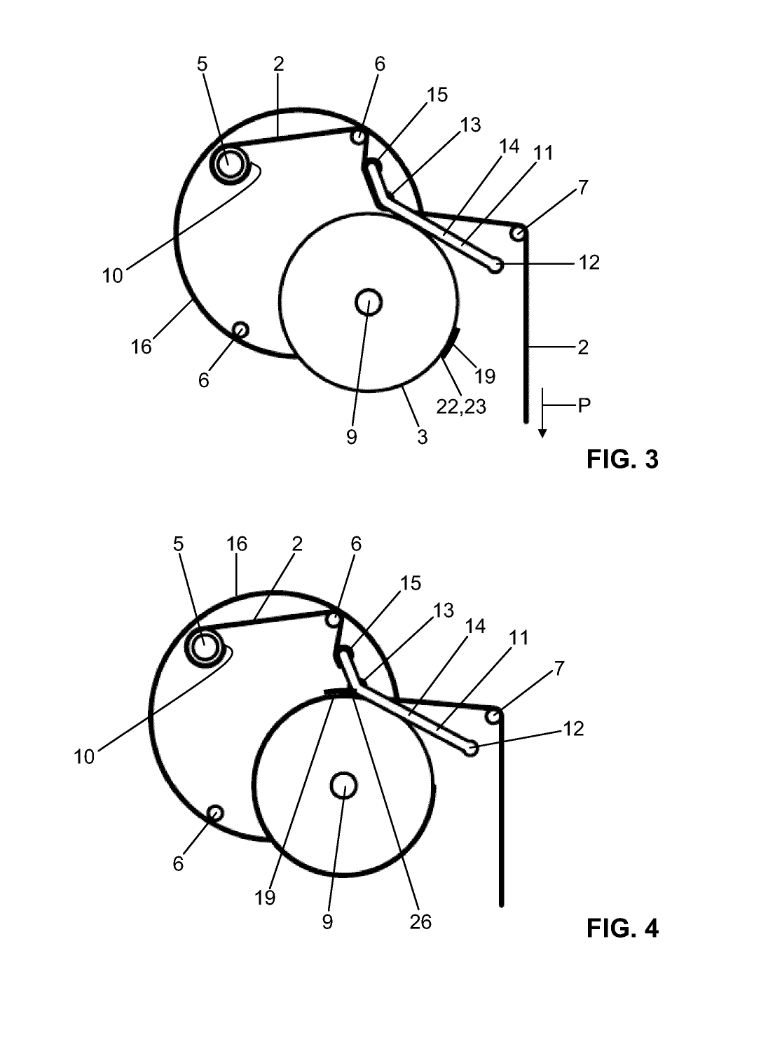

The turret wheel 16 can essentially assume two positions, namely a starting position and a splicing position. The starting position is shown in FIG. 2. The active reel 4 is thereby located above the passive reel 8 and the active film web 2 is unwound from the active reel 4, the active film web 2 being guided here via the second deflection roller 7. The position shown in FIG. 2 relates to the normal position during unwinding. In this position, the old reel comprising the remaining film quantity is also preferably replaced by a new reel. In an advantageous manner, the relevant rotational axis always comes to rest at the same location, which allows the reel to be easily changed. The passive reel 8 is situated here in the waiting position. If the fill level of the active reel falls below a certain amount, the process moves to the splicing location shown FIGS. 3 and 4 and the two film webs can be spliced to one another.

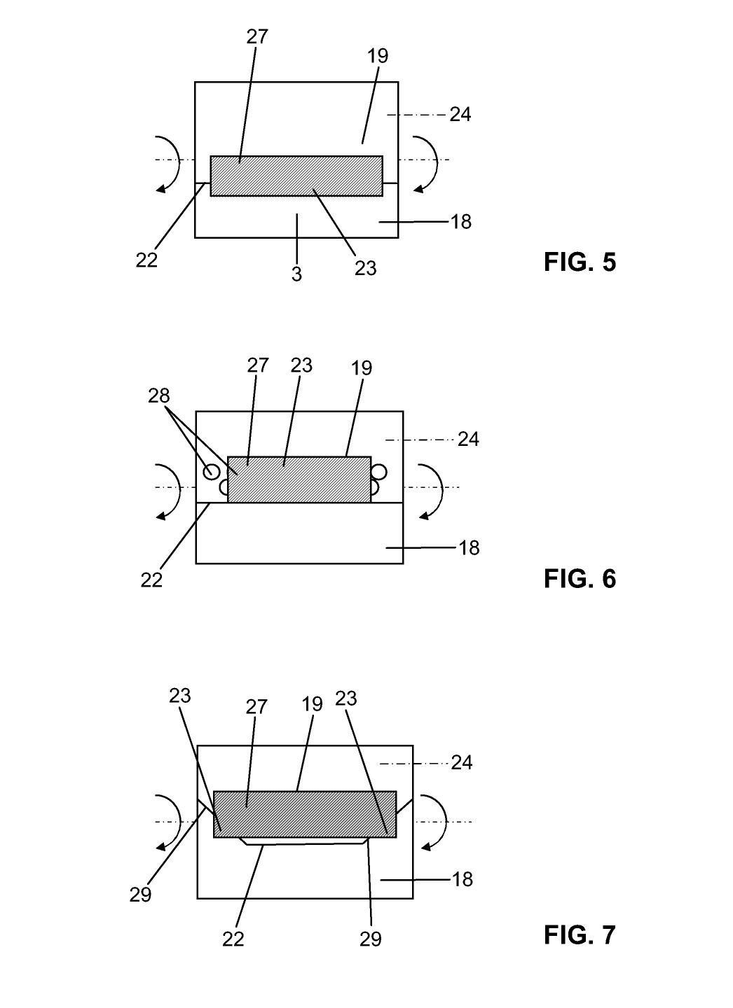

Before the operation of splicing, the outer side 18 of the passive film web 3 is provided with a connecting element 19 proximate to or at the film start 22. The connecting element 19 serves in this case as a splicing means for connecting the active film web 2 to the passive film web 3. The connecting element 19 can be embodied in different ways. This preferably relates to an adhesive element, such as an adhesive tape, a double-sided adhesive tape or to adhesive spots or adhesive strips, which are applied to the outer side 18 of the passive film web 3. Further alternatives for the connecting element 19 are explained with the aid of FIGS. 5 to 7.

This preparation can be carried out if the reel has already been placed on the machine. The new reel can, however, also be prepared right before being mounted to the machine. The reels can already have been prepared when put into stock or can even have been prepared when procured from a supplier.

When or after a remaining film quantity of the active film web 2 has been reached on the active reel 4, the active film web 2 is then spliced to the passive film web 3, with the result that the passive film web 3 is pulled into the at least one processing station and therefore changes from the passive film web 3 into the active film web 2.

The remaining film quantity can, for example, be detected by measuring the diameter of the reel or by recognizing special printed marks or position marks in the region of the film end which signal the film end. As an alternative, the film end can be directly detected. It would also be conceivable to measure the angular speed of the reel and the film speed, whereby the diameter of the film can thus be determined. The splicing device comprises a corresponding sensor unit for taking these measurements. The sensor unit can also be disposed outside of the splicing device, the splicing device being then supplied with corresponding data.

Temporally prior to the operation of splicing, the turret wheel 16 rotates into the splicing position and the passive reel can be prepositioned with respect to the connecting element 19 or the centering mark. Prior to or shortly after the remaining film quantity being/having been reached, temporally shortly before the operation of splicing, the active film web 2 is moved into the proximity of the passive film web 3, wherein the two film webs 2, 3 can be prepositioned relative to one another. The splicing device then lies substantially in the splicing position. In order to perform the prepositioning and the splicing, the splicing device 1, in particular the turret wheel 16, pivots in the present embodiment, and the pressing unit 11 comes into contact with the active film web 2. The active film web 2 is then guided via the first deflection roller 6 of the turret wheel 16, the deflection roller 15 and the pressing roller 13 of the pressing unit 11 to the second deflection roller 7. In so doing, the pressing unit 11 comes to rest by means of the pressing roller 13 such that said pressing roller 13 comes to rest at a small amount of distance to the outer side 18 of the passive film web 3. By a small amount of distance, a distance is understood which is dimensioned such that a contact between the two films can just be ruled out.

Prior to the operation of splicing, the active film web 2 and the passive film web 3 are moved relatively towards one another. During the splicing operation, the active film web 2 is pressed against the passive reel 8 comprising the passive film web 3, and in this way the passive film web 3 is spliced via the connecting element 19 to the active film web 2. The pressing roller 13 of the pressing unit 11 is moved further against the passive reel 8 and therefore presses the active film web 2 against the passive film web 3 or, respectively, against the connecting element 19 of the passive film web 3, whereby a splicing of the active film web 2 to the passive film web 3 occurs.

Immediately prior to the operation of splicing, the passive reel 8 is preferably accelerated such that the peripheral speed of the passive reel 8 is equal to the speed of the active film web 2, wherein the active film web 2 moves in the same direction as the passive film web 3. The splicing can therefore occur without throttling the speed, which has the advantage that the movements at the further processing machines likewise do not have to be throttled. As a result, an improved splicing position furthermore occurs because the two film webs have approximately the same speed during the splicing operation. In order to provide this acceleration, the corresponding rotational axis, in this case the second rotational axis 9, is provided with a drive motor. In so doing, each rotational axis 5, 9 is furnished with a separate drive motor, or a single drive motor is provided which is coupled to the corresponding rotational axis.

In a further embodiment, the movement of the passive reel 8 can be synchronized with the movement of the active film web 2. In so doing, possible imprints or the possible print image on the active film web 2 can run synchronously, in particular position-synchronously, with those of the passive film web 3. A correction of the position of the print image at the processing machine can thus be omitted. As a result, the number of products is greatly reduced which have a false position of the print image after the splicing operation and therefore must be removed.

In order to detect the speed and/or position of the imprints for synchronization, the films can have corresponding position marks, centering marks or control marks. As an alternative, it would also be possible to detect the connecting element 19 and to control among other things the speed or the synchronous operation on the basis of the connecting element 19. It should also be mentioned in this context that the film speed of the active film web can likewise be detected, wherein said film speed can then be compared to the likewise detected speed of the drive of the reel, and error conditions can thus be detected. If such an error condition should occur, it would be conceivable that an emergency splicing is introduced.

The detection of marks or imprints on the reel comprising the passive film web 3 has yet additionally the advantage that it can be detected whether the reel 8 was correctly inserted in the splicing device with respect to the relative position to the reel 4 comprising the active film web 2.

The marks or imprints can be disposed such that the reel can be controlled as to the position thereof shortly after said reel has been mounted to the corresponding rotational axis. It is particularly conceivable that the marks are disposed laterally on the film web. In so doing, it can be detected whether the reel is lying correctly in the machine and not rotated out of place by 180.

Immediately after the splicing operation has been completed, the film web 2, which was the active film web prior to splicing, is severed. To this end, a corresponding cutting tool can be disposed on the pressing unit 11.

Likewise after the splicing operation has been completed, the active reel, in this case then the second reel 8, is further pivoted by the turret wheel 16 so that the active reel 8 comes to rest above the reel, in this case the first reel 4 comprising the remaining film quantity. The first reel 4 comprising the remaining film quantity can subsequently be removed from the splicing device and be replaced by a new reel which then constitutes the passive reel. The starting state in FIG. 2 is thus reestablished.

The pivoting of the turret wheel into the starting position has the advantage that the reel to be replaced always lies at the same position; thus enabling the replacement of the reels to be easier for the machine operator and if applicable to be automated.

In an alternative embodiment, the rotational axes 5, 9 could also be fixedly disposed or could be able to move in a non-circular path.

In conjunction with FIGS. 3 and 4, it can be seen that the inner side 20 of the active film web 2 is connected to the outer side 18 of the passive film web 3. The two film webs 2, 3 therefore have the same orientation. That means that a perpendicular line from the outer side 18 of the passive film web 3 and a perpendicular line from the outer side 21 of the active film web 2 extend in the same direction. As a result, the fabrication of different wheels in left and right versions is not necessary, which increases the operating reliability of the splicing device. This results from the fact that the reels cannot be reversed when being inserted into the device.

The start 22 of the passive film web 3, which is spliced to active film web 2, is preferably connected via a locking device, in this case an adhesive connection 23, to the outer side 18 of the passive film web 3. As a result, an accidental unwinding of the passive film web 3 is prevented. The locking device or the adhesive connection 23 is preferably designed such that it has a lower resistance than the connecting element 19 at the spliced connection or that said lower resistance is provided by an intended tearing point at the adhesive connection 23. The spliced connection comprising the connecting element 19 is thus configured stronger with respect to mechanical forces than the adhesive connection 23 between the inner side 24 and the outer side 18 of the passive film web. In other words, it can therefore be said that the adhesive connection 23 is designed such that the film start 22 is not detached from the reel 8 when the film web 3 is accelerated and that the adhesive connection 23 can be reliably disjoined after splicing has been completed, whereas the spliced connection via the connecting element 19 is thereby not disjoined.

The adhesive connection 22 can, for example, be formed with a cold adhesive or a similar adhesive. When using a so-called cold sealing film, in which a cold adhesive is applied to the inner side of the film, said cold adhesive serving to connect the seams during production of the packaging, said cold adhesive can serve as an adhesive connection 23.

In particularly preferred embodiments, it would be additionally conceivable that the adhesive connection 23 and the connecting element 19 are provided with the same adhesive element. For this purpose, the connecting element 19 has to be mounted to the outer side of the outermost layer of the reel.

It would also be alternatively conceivable to dispense with the adhesive connection 23, wherein the film start 22 is then connected to the outer side 18 of the passive film web by means of static charging.

FIGS. 5 to 7 show different embodiments of the adhesive connection 23. The prepared reel 8 comprising the passive film web 3 is depicted in all of the figures.

In FIG. 5, the film start 22 is connected to the outer layer of the reel comprising the film web 3 by means of a double-sided adhesive tape 27. The adhesive connection 23 is therefore provided by a double-sided adhesive tape 27. The adhesive tape 27 can, for example, be an adhesive tape known by the trade name “easy splice tape”. It is important that when using adhesive tape 27, the connection 23 between the film start and the outermost layer of the reel provides a lower resistance than the connecting element 19, as has been described earlier.

In FIG. 6, the double-sided adhesive tape 27 pursuant to FIG. 5 is likewise depicted. Similar parts are provided with the same reference numerals. In addition, the film start comprises in this case a multiplicity of openings 28, by means of which the adhesive connection 23, i.e. the locking device, between the film start and the outer layer of the reel is formed. The openings 28 can be disposed offset to one another in two or more rows. The adhesive tape 27 serves with the outer side thereof as the connecting element 19. The disposal of a separate connecting element 19 is also conceivable.

A similar embodiment pursuant to FIGS. 5 and 6 is likewise depicted in FIG. 7. Once again identical parts are provided with the same reference numerals. The film start 22 is in this case designed having cut-off corners, wherein two edges 29 are thus provided which extend inclined or at an angle to the film web. Because the adhesive tape 27 protrudes beyond the cut-off corners, the adhesive connection 23 or, respectively, the locking device is formed at this location. The adhesive tape 27 with the outer side thereof also serves in this instance as the connecting element 19. The disposal of a separate connecting element 19 is however also conceivable.

Instead of the adhesive tape in FIGS. 5 to 7, hot glue dots/dashes, which serve as connecting elements 19, can be applied to the start region of the film shortly prior to splicing. To this end, the film start has to be marked when preparing the new film. During the splicing operation, the end piece of the old reel is connected to the initial piece of the new reel by means of said hot glue.

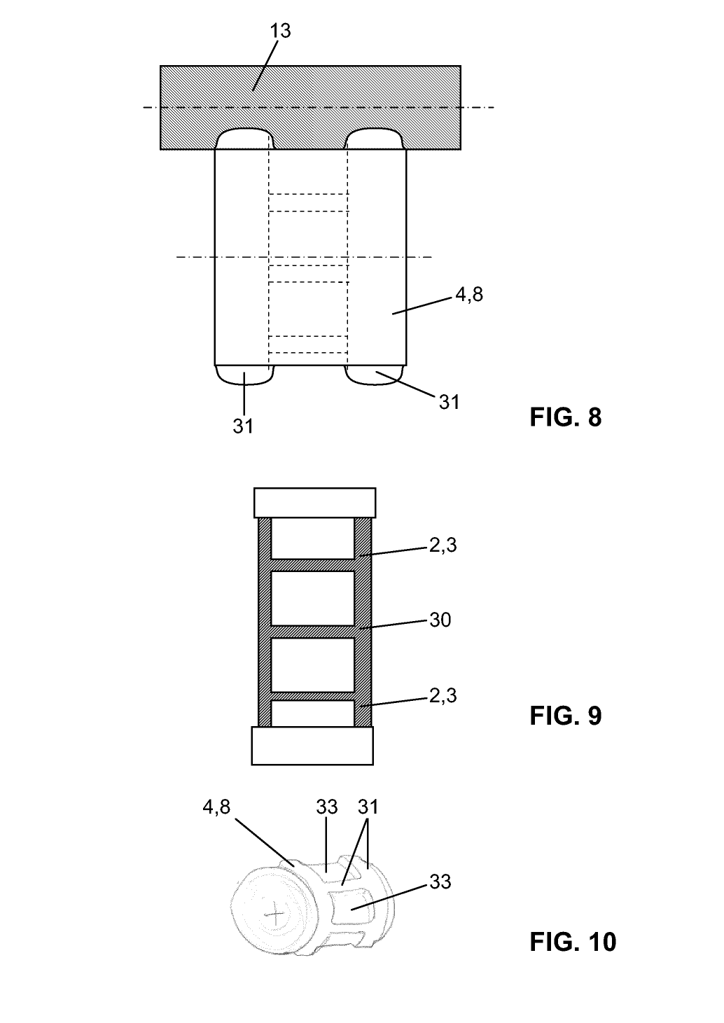

A film web 2, 3 is shown in FIGS. 8 and 9 which has an application of cold glue 30 on the inner side of said film web. It can be seen clearly in FIG. 8 that the cold glue application 30 can lead to regions 31 having a larger diameter of the reel. In order to achieve a good splice as described earlier despite the elevated regions 31, an adaptation of the pressing roller 13 is necessary. For example, the pressing roller 13, as shown in FIG. 8, can consist of a soft material; thus enabling said pressing roller 13 to deform according to the shape of the reel 4, 8. Said pressing roller 13 can also alternatively comprise elevations and depressions, which are then adapted to the elevations and depressions on the reel 4, 8. A plurality of individually mounted and spring loaded rollers can be disposed instead of the pressing roller 13.

In summary it can be emphasized that the splicing device and the splicing method according to the present invention have the following advantages:
The preparation of the film to be newly inserted can be done outside of the machine and always in the same way regardless of whether left or right reel, whereby the error source can be minimized, which leads to fewer malfunctions.
The splicing can be performed at full speed because the new film was already accelerated prior to the splicing operation. As a result, the new film does not experience any acceleration after the splicing operation, whereby higher speeds are possible.
The risk is less that the film start of the new film is pulled in too early by the operating machine because the new film first comes into contact with the exhausted film during the splicing operation.
An unnecessary, premature overlapping of the film, as is typical with conventional splicing methods, can be prevented. In so doing, malfunctions can be prevented due to loose, advancing film parts becoming snagged or stuck.
Less film overlapping as in conventional methods, i.e. fewer packagings have to be discarded.
Preparation of the reel can occur independently of a centering mark. Centering occurs automatically and therefore a faulty preparation does not occur. As a result, there is less waste and less risk that the machine stops on account of uncentered products.
Since the reels are all prepared in the same manner, a fully automatic changing of reels is also possible

1. A splicing method for connecting an active film web (2) which is wound up on a first reel (4) to a passive film web (3) which is wound up on a further reel (8), wherein the active film web (2) is unwound from the first reel (4) and is fed to at least one processing station, and wherein when a remaining film quantity of the active film web (2) is reached on the first reel (4), the active film web (2) is spliced or connected to the passive film web (3), with the result that the passive film web is pulled by the active film web (2) into the at least one processing station and therefore changes from the passive film web into the active film web, characterized in that an outer side (18) of the passive film web (3) is provided with a connecting element (19) before the active film web (2) is spliced to the passive film web (3), and in that the active film web (2) and the passive film web (3) are moved relatively towards one another, wherein the active film web (2) is pressed against the further reel (8) with the passive film web (3) and the passive film web (3) is thus spliced to the active film web (2) via the connecting element (19).

2. The splicing method according to claim 1, characterized in that the further reel (8) with the passive film web (3) is accelerated before the active film web (2) is spliced to the passive film web (3) such that the peripheral speed of the further reel (8) is substantially equal to the speed of the active film web (2), wherein the passive film web (3) and the active film web (2) move in the same direction.

3. The splicing method according to claim 1, characterized in that the movement of the further reel (8) with the passive film web (3) is synchronized with the movement of the active film web (2), whereby the active film web (2) and the passive film web (3) run position-synchronously to each other.

4. The splicing method according to claim 1, characterized in that the active film web (2) is severed after splicing of the active film web (2) to the passive film web (3) has been completed.

5. The splicing method according to claim 1, characterized in that the inner side (20) of the active film web (2) is connected to the outer side (18) of the passive film web (3) during splicing of the active film web (2) to the passive film web (3), thus enabling the active film web (2) and the passive film web (3) to have the same orientation with respect to the surfaces thereof.

6. The splicing method according to claim 1, characterized in that the start (22) of the passive film web (3), which is spliced to the active film web (2), is secured to the rolled-up passive film web with a locking device (23), wherein the locking device (23) is provided via an adhesive connection (23).

7. The splicing method according to claim 6, characterized in that the connecting element (19) for the spliced connection provides the adhesive connection (23) at the same time.

8. The splicing method according to claim 1, characterized in that the active film web and the passive film web are moved towards one another if a predetermined remaining film quantity of the active film web (2) is detected.

9. A splicing device for producing a spliced connection (26) of an active film web (2) which is wound up on a first reel (4) to a passive film web (3) which is wound up on a further reel (8), wherein the active film web (2) is unwound from the first reel (4), characterized in that the splicing device comprises a first rotational axis (5) comprising the first reel (4), at least one further rotational axis (9) comprising respectively a the further reel (8) and a pressing unit (11), wherein the further reel (8) with the passive film web (3) has a connecting element (19) on an outer side (18) thereof and wherein the active film web (2) and the passive film web (3) can be moved relatively towards one another by means of the pressing unit (11) before an operation of splicing, wherein the active film web (2) can be pressed against the further reel (8) with the passive film web (3) by means of the pressing unit (11), and the film web (3) can thus be spliced to the active film web via the connecting element (19).

10. The splicing device according to claim 9, characterized in that a drive is disposed in each case per rotational axis (5, 9), or a common drive is available for all of the rotational axes (5, 9), which common drive can be coupled to the rotational axis (5, 9), wherein the drive accelerates the corresponding rotational axis (5, 9) comprising the reel disposed on said rotational axis (5, 9) such that a peripheral speed of the reel (8) is equal to a speed of the active film web (2).

11. The splicing device according to claim 9, characterized in that the rotational axes (5, 6) are accelerated by the drive such that the movement of the passive film web (3) can be synchronized with the active film web (2), whereby the active film web (2) runs position-synchronously with the passive film web (3).

12. The splicing device according to claim 9, characterized in that the pressing unit (11) comprises a pressing roller (13), with which the active film web (2) can be pressed against the further reel (8) with the passive film web (3).

13. The splicing device according to claim 9, characterized in that the splicing device comprises a sensor unit for detecting a remaining film quantity of the active film web.

14. The splicing device according to claim 9, characterized in that the splicing device comprises a turret wheel (16), on which the rotational axes (5, 9) are disposed, wherein the turret wheel (16) can be pivoted about a rotational axis (17) so that the rotational axes (5, 9) can be pivoted respectively from a start position into a splicing position, in which the active film web (2) can be spliced to the passive film web (3).

15. The splicing device according to claim 14, characterized in that the active film web (2) and the passive film web (3) can be moved in the proximity of each other via the turret wheel (16) before the operation of splicing, wherein a prepositioning of the active film web with respect to the passive film web can be performed.

16. The splicing method according to claim 8, characterized in that splicing is triggered if the predetermined remaining film quantity of the active film web (2) is detected.

17. The splicing method according to claim 16, wherein the remaining film quantity is detected by measuring the diameter of the reel.

18. The splicing method according to claim 16, wherein the remaining film quantity is detected by detecting at least one mark in the region of the film end (10) of the film web (2).

19. The splicing method according to claim 1, characterized in that splicing is triggered if a predetermined remaining film quantity of the active film web (2) is detected.

20. The splicing device according to claim 12, characterized in that the pressing unit (11) comprises a cutting tool, with which the active film reel (2) can be severed after the splicing operation.

21. The splicing device according to claim 20, characterized in that the pressing unit (11) comprises a pressing roller (13), with which the active film web (2) can be pressed against the further reel (8) with the passive film web (3).
